(19) United States
(12) Patent Application Publication
(10) Pub. No.: US 2011/0251854 A1
(43) Pub. Date: Oct. 13, 2011

(54) PC-BASED ACCESS METHOD BETWEEN ELECTRONIC MEDICAL RECORD SYSTEM AND INTERNET-BASED PERSONAL HEALTH RECORD ACCOUNT

(76) Inventor: He-Doo Chung, Seoul (KR)

(21) Appl. No.: 12/756,562

(22) Filed: Apr. 8, 2010

(51) Int. Cl. G06Q 50/00; G06F 21/00; G06Q 10/00

(52) U.S. Cl. 705/3; 726/28

(57) ABSTRACT

A PC-based access method between an EMR system and an Internet-based PHR account is disclosed. A doctor inquires and creates the EMR data on a patient recorded in the EMR system of a hospital/medical clinic using an EMR access module installed in a doctor's office terminal and, accesses a PHR account of a patient that resides on the Internet and inquires and creates the PHR data on the patient stored in a PHR system.

### BACKGROUND OF THE INVENTION

1. Field of the Invention

The present invention relates to a doctor's office PC-based access method between electronic medical record (EMR) systems of hospitals/medical clinics and Internet-based personal health record (PHR) accounts and, more particularly, to a doctor's office PC-based access method between the EMR systems and Internet-based PHR accounts enabling a doctor to inquire and create EMR data on a patient recorded in the EMR system of a hospital/medical clinic using an EMR access module provided in a doctor's office terminal and, at the same time, to access a PHR account of a patient that resides on the Internet and to inquire and create PHR data on the patient stored in a PHR system.

2. Description of the Related Art

The medical record of a hospital/medic clinic including symptoms, medical history, examination result, and cure record of a patient is traditionally written out on a paper medical chart to be kept in the paper medical chart storage of the hospital/medical clinic. The medical record of the hospital/medical clinic is transferred to a doctor's office so that a doctor inquires and records the contents of the paper medical chart when a patient visits the hospital/medical clinic. Recently, hospitals/medical clinics are increasingly introducing an electronic medical record (EMR) system electronically inquiring, recording, and storing medical record.

Like the medical record data on a patient recorded in the paper medical chart, the medical record data on a patient stored in the EMR system is also recorded in a server of a hospital/medical clinic. Therefore, there are many limitations on the patient and/or a doctor of another hospital/medical clinic who treats the patient inquiring and using the medical record data.

Such limitations interfere with patient treatment when the patient is treated by another hospital/medical clinic or an emergency occurs. Due to such limitations, examination results obtained by another hospital/medical clinic are not acquired by a corresponding hospital/medical clinic so that various problems in which the patient receives the same examination occur.

In order to solve such problems, recently, the concept of a personal health record (PHR) in which health information on a patient such as medical record data, disease history, and medicine dose history kept in the hospitals/medical clinics is created and managed by the patient so that the patient can be managed and treated at any domestic or foreign medical institution, appears.

There are typical methods that have appeared so far in order to manage the PHR such as a paper-based PHR in which a patient creates his or her paper medical chart to manage the same, a PC-based PHR in which a patient creates his or her health record in his or her PC to manage the same, a portable-storage PHR in which a patient creates his or her health record in a USB flash drive, a memory stick, or a smart card that the patient can carry to manage the same, and an Internet-based PHR in which a patient creates his or her health record account in a server on the Internet to manage the same.

Among the above methods, in particular, the Internet-based PHR is expected to become a typical method of managing the PHR due to the development of the Internet and the rapid distribution of the EMR system of a hospital/medical clinic.

However, since data format or communication protocol of the EMR system used by a hospital/medical clinic is not developed and customized for the environments of hospitals/medical clinics and the conditions of developers to be standardized, it is very difficult for the PHR account on the Internet and a plurality of EMR systems to exchange data on a patient.

In a hospital/medical clinic where an EMR system is established, a doctor searches for a patient using an EMR communication module provided in a terminal of a doctor's office to inquire or record medical record data on the patient.

Therefore, in order for a doctor who accesses the EMR system and treats a patient to inquire or record data stored in the Internet-based PHR account of the patient, the PHR database of a PHR system and an EMR database of the EMR system are synchronized and the data on the patient may be automatically updated between the two systems.

However, in order to synchronize data between the PHR system and a plurality of EMR systems that are not standardized, a data synchronization standard on the EMR system must be provided and the EMR systems of hospitals/medical clinics must be re-constructed to be suitable for the data synchronization standard. It is very difficult to correct the EMR systems of the plurality of hospitals/medical clinics corresponding to clients in order to access a small number of PHR systems to be managed by a government or private portals.

On the other hand, although data is synchronized between the PHR system and the EMR system, a doctor directly drives a web browser or a PHR access program to access the PHR system and inputs a PHR ID of the corresponding patient to access the PHR account.

However, information stored in the PHR account corresponds to very important personal information such as diseases, treatment history, health state, and medicines that are being currently taken. Therefore, access to the account is to be selectively allowed so that only individuals authorized to access the information by the patient may access the account.

In order for a doctor to access the PHR account of the patient, processes of registering the terminal of a doctor's office requesting access, inputting the PHR ID of the patient, and allowing the access to the PHR account of the patient by the registered terminal of the doctor's office are to be performed. Such processes are to be repeated in the case where a patient treated once is subsequently treated as well as in the case where the access to the PHR account of another patient is made. Therefore, the performance of the processes is very annoying to a doctor who has to treat many patients within limited time.

### SUMMARY OF THE INVENTION

Therefore, in order to solve the above problems so that the PHR system is successfully introduced and diffused, it is necessary to standardize a plurality of EMR systems corresponding to clients so that only individuals authorized by a patient can access the PHR account. Development of an access method, by which a doctor may easily synchronize an EMR screen on a patient whom the doctor is treating and the PHR account of a corresponding patient synchronize to inquire and record information, is required.

In accordance with an embodiment of the present invention, there is provided a PC-based access method between an electronic medical record (EMR) system and an Internet-based PHR account, including: accessing the EMR system, by an EMR access module of a doctor's office terminal, connected through an intranet when treatment of a patient is begun to search for and activate EMR and patient number data of the patient; extracting, by a personal health record (PHR) access module of the doctor's office terminal, the patient number data in the EMR of the patient currently activated from a memory of a corresponding doctor's office terminal; accessing, by the PHR access module of the doctor's office terminal, a PHR system connected through the Internet using a set hospital/medical clinic code to check whether the extracted patient number matches the set hospital/medical clinic code in a hospital/medical clinic authentication table of the PHR system; determining, by the PHR access module of the doctor's office terminal, whether a PHR ID matches a corresponding patient number present in the hospital/medical clinic authentication table of the PHR system, when it is determined that the extracted disease record number matches the set hospital code; transmitting, by the PHR access module of the doctor's office terminal, a PHR account access code of the corresponding patient and comparing the PHR account access code with an access code previously registered in a patient authentication table of the PHR system to perform PHR account access authentication, when it is determined that the PHR ID matches the corresponding patient number; and accessing, by the PHR access module of the doctor's office terminal, the PHR account of the corresponding patient stored in a PHR database of the PHR system to read PHR data and to activate the PHR data together with the EMR of the corresponding patient, when the PHR account access authentication process is completed.

In the PC-based access method according to the present invention between an EMR system and an Internet-based PHR account, a PHR account screen that is automatically synchronized with the EMR system simply by an initial process without a doctor performing processes of inputting the PHR account of a patient and obtaining the access approval of the patient every time treatment is performed in order to access the PHR system may be provided.

In addition, the EMR systems currently classified by the environments of hospitals and the features of system developers are standardized to synchronize the EMR system with the PHR system effectively.

### BRIEF DESCRIPTION OF THE DRAWINGS

The objects, features and advantages of the present invention will be more apparent from the following detailed description in conjunction with the accompanying drawings, in which:

FIG. 1 is a schematic view illustrating an existing method of managing an EMR system;

FIG. 2 is a schematic view illustrating an existing method of managing a PHR system;

FIG. 3 is a schematic view illustrating an ideal method of synchronizing an EMR system with a PHR system;

FIG. 4 is a schematic view illustrating a method of synchronizing an EMR system with a PHR system according to an embodiment of the present invention;

FIG. 5 is a schematic view illustrating a method of connecting a PHR system and a terminal of a doctor's office according to an embodiment of the present invention;

FIG. 6 is a view illustrating the authentication database of the PHR system according to the embodiment of the present invention; and

FIG. 7 is a flowchart illustrating a PC-based access method between the EMR system and the Internet-based PHR account according to an embodiment of the present invention.

### DETAILED DESCRIPTION OF EXEMPLARY EMBODIMENTS

Hereinafter, embodiments of the present invention will be described in detail with reference to the accompanying drawings.

Hereinafter, for the purpose of correct understanding of the present invention, methods of managing an existing electronic medical record (EMR) system and an existing personal health record (PHR) system that operate separately will be described, respectively, an ideal management pattern for synchronizing the EMR system with the PHR system will be described, and the embodiments of the present invention as a practical alternative will be described.

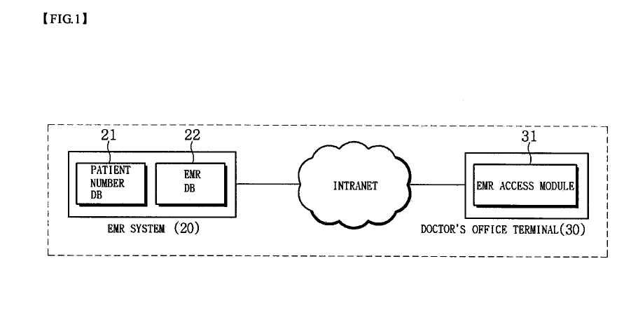

First, FIG. 1 is a schematic view illustrating an existing method of managing an EMR system.

As illustrated in FIG. 1, an EMR system 20 serves to process a medical record of a hospital/medical clinic. The EMR system 20 includes an EMR database 22 for storing EMRs and a patient number DB 21 for managing patient numbers for medical records of patients.

The patient number is a patient identification referred to as a chart number. One patient number is given to each of the patients of hospitals/medical clinics to be managed.

A doctor's office terminal 30 accesses the EMR system 20 through an EMR access module 31 installed therein. The EMR system 20 searches, creates, and corrects the EMR for each of the patients by inputting a patient number.

The doctor's office terminal 30 may be a computer used and managed by a single doctor or, may be a shared computer commonly used and managed by a plurality of doctors.

The doctor's office terminal 30 and the EMR system 20 may be connected to each other by an intranet so that external access to the EMR information in the EMR system 20 of a corresponding hospital/medical clinic is blocked.

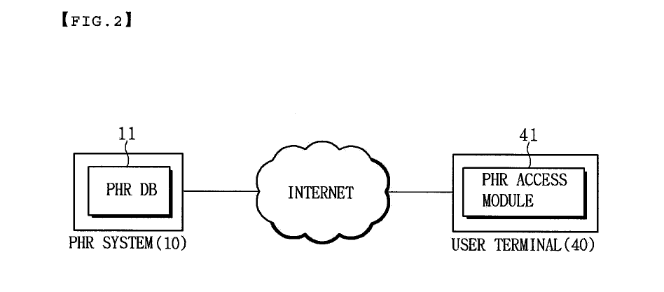

Next, FIG. 2 is a schematic view illustrating an existing method of managing a PHR system.

As illustrated in FIG. 2, a PHR system 10 allows a patients to create and manage personal medical record data of the patient kept in each of the hospitals/medical clinics or health information such as a past disease history and a medicine dose history using the Internet, and includes a PHR database 11 in which personal health record information on the patient is kept and managed through a personal account of the patient.

Since very important personal information such as information on a disease, a treatment history, a health state, and medicines that are being taken is included in the PHR, the PHR is managed such that only individuals authorized by the patient may access the information.

A user terminal 40 accesses the PHR system 10 through a PHR access module 41 provided therein and accesses a user account through personal authentication to search, create, and correct PHR data.

The user terminal 40 and the PHR system 10 may be connected to each other through a public network, that is, the Internet to be accessed regardless of time and place when authentication for a user account may be performed.

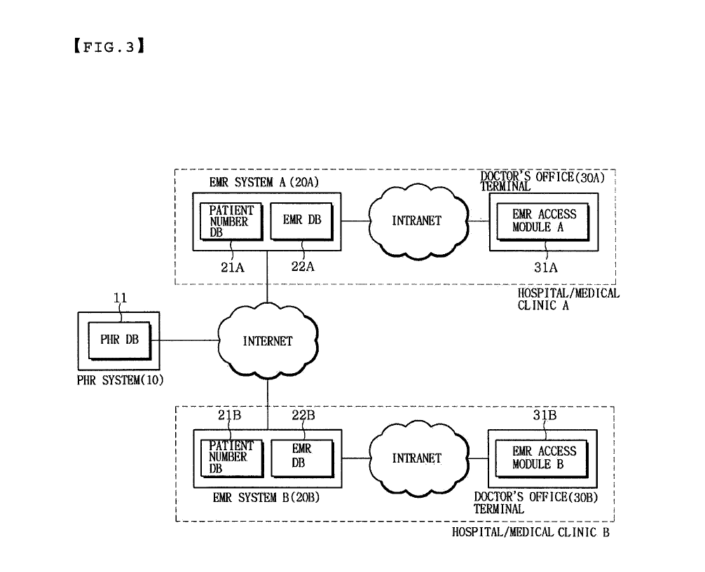

Next, FIG. 3 is a schematic view illustrating an ideal method of synchronizing the EMR system with the PHR system.

As illustrated in FIG. 3, a hospital/medical clinic A includes an EMR system 20A and a doctor's office terminal 30A connected to each other through an intranet of the hospital/medical clinic A and a hospital/medical clinic B includes an EMR system 20B and a doctor's office terminal 30B connected to each other through an intranet of the hospital/medical clinic B.

Since the EMR systems 20A and 20B of the hospitals/medical clinics A and B are not standardized and customized for the environments of the hospitals/medical clinics A and B and the conditions of EMR system developers, an EMR system A and an EMR system B are separately indicated by 20A and 20B in the drawing. Since EMR access modules are separately developed and customized for the EMR systems, the EMR access modules are indicated by an EMR module A and an EMR module B.

As illustrated in FIG. 3, the PHR system 10 is connected to the EMR systems A and B 20A and 20B of the hospitals/medical clinics through the Internet.

When the EMR systems 20A and 20B and the PHR system 10 are ideally synchronized with each other, data stored in the PHR database 11 of the PHR system 10, data stored in the EMR database 22A of the EMR system A 20A, and data stored in the EMR database 22B of the EMR system B 20B are automatically updated in a synchronous fashion. Therefore, a doctor may treat a patient while inquiring and recording the EMR data of the patient stored in the EMR systems A and B 20A and 20B and the PHR data of the patient stored in the PHR system 10 through EMR access modules A and B 31A and 31B on the doctor's office terminals 30A and 30B.

However, although the EMR system and the PHR system are ideally synchronized with each other as described above, when the EMR systems and the PHR systems of the hospitals/medical clinics are synchronized in the current state wherein a plurality of EMR systems that are not standardized are constructed in the hospitals/medical clinics, the synchronization of all EMR systems of hospitals/medical clinics has difficulties such as standardization for exchanging data and correction or re-construction of the existing EMR systems of all of the hospitals/medical clinics.

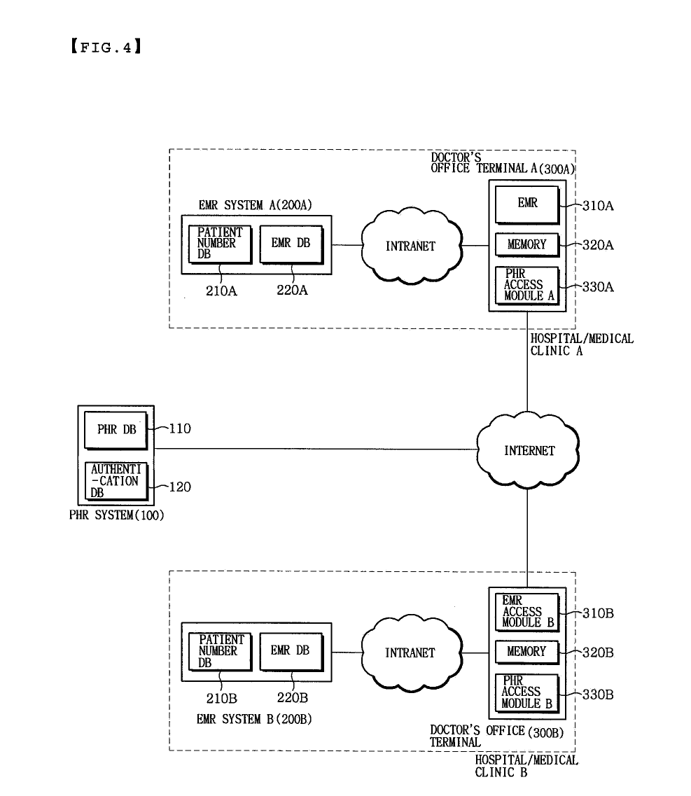

Next, FIG. 4 is a schematic view illustrating a method of synchronizing an EMR system with a PHR system according to an embodiment of the present invention.

As illustrated in FIG. 4, a hospital/medical clinic A includes an EMR system A 200A and a doctor's office terminal 300A connected to each other through an intranet of the hospital/medical clinic A 200A and a hospital/medical clinic B includes an EMR system B 200B and a doctor's office terminal 300B connected to each other through an intranet of the hospital/medical clinic B 200B. In this case, a PHR system 100 is connected to the doctor's office terminals 300A and 300B of the hospitals/medical clinics A and B through the Internet.

First, the PHR system 100 includes a PHR database 110 in which PHR information on a patient is stored and managed through a personal account and an authentication database 120 in which data required for synchronizing the EMR systems with a PHR account is stored.

The EMR systems A and B 200A and 200B include EMR databases 220A and 220B in which EMR is stored and patient number databases 210A and 210B for managing identification numbers for the personal medical records of patients.

The doctor's office terminals 300A and 300B connected to the EMR systems A and B 200A and 200B by the intranet of the hospitals/medical clinics A and B search, create, and correct the EMR on the patients by inputting the patient numbers using the provided EMR access modules 310A and 310B. The doctor's office terminals 300A and 300B access the PHR system 100 connected through the Internet by PHR access modules A and B 330A and 330B and access the account through personal authentication to search, create, and correct the PHR data.

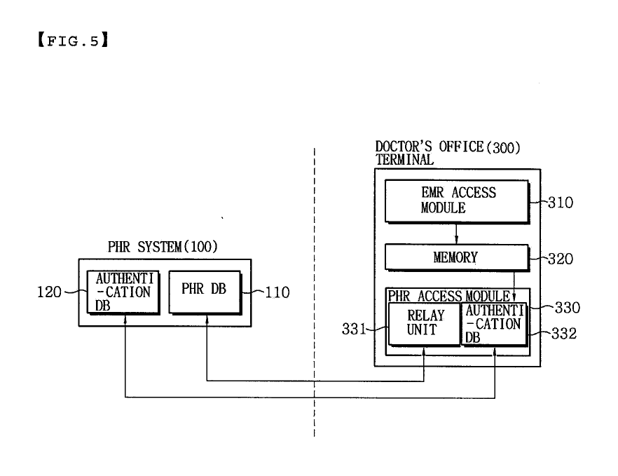

Referring to FIG. 5, each of the PHR access modules A and B 330A and 330B includes an authentication unit 332 for performing an authentication process required for synchronizing a corresponding patient account of the PHR system 100 in the state where the doctor's office terminals 300A and 300B access the EMR systems A and B 200A and 200B and a relay unit 331 for reading the data on the synchronized PHR patient account from the PHR database 110 to relay the data to the corresponding doctor's office terminals 300A and 300B.

In most cases, since different EMR systems are used by the hospitals/medical clinics, the PHR access modules A and B 330A and 330B are optimized in accordance with EMR system manufacturing companies and installed in the doctor's office terminals 300A and 300B.

The respective EMR systems will be described in detail with reference to FIGS. 4 to 6.

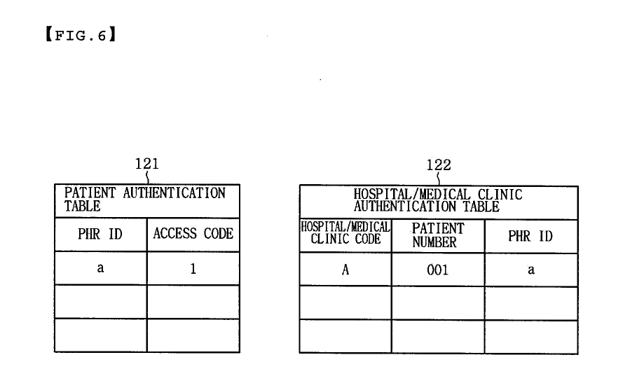

As illustrated in FIG. 6, a patient authentication table 121 and a hospital/medical clinic authentication table 122 in which data referred to by the authentication units 332 of the PHR access modules A and B 330A and 330B is stored are loaded in the authentication database 120 of the PHR system 100 in order to synchronize the EMR systems A and B 200A and 200B with the PHR account.

The patient authentication table 121 includes PHR IDs and access codes and the hospital/medical clinic authentication table 122 includes hospital/medical clinic codes, patient numbers, and the PHR IDs.

The PHR ID of the patient authentication table 121 is data required for looking for the PHR account of a patient in the PHR system 100 and is set when the patient creates the PHR account.

The access code of the patient authentication table 121 is used to allow the PHR access module to access the PHR account of the patient and is set when the patient creates the PHR account.

The hospital/medical clinic codes of the hospital/medical clinic authentication table 122 are previously input as identifications of hospitals/medical clinics or doctors in a PHR system 100 constructing process.

When the PHR access modules A and B 330A and 330B of the doctor's office terminals 300A and 300B are installed, users of the doctor's office terminals 300A and 300B search the hospital/medical clinic codes of the corresponding hospitals/medical clinics to register the hospital/medical clinic codes in the authentication units 332 of the PHR access modules A and B 330A and 330B.

The patient numbers of the hospital authentication tables 122 are identifications required for looking for the account of a patient from the EMR databases 220A and 220B of the hospital/medical clinic EMR systems A and B 200A and 200B. Each of the authentication units 332 of the PHR access modules A and B 330A and 330B matches the patient numbers read from memories 320A and 320B of the doctor's office terminals 300A and 300B during the operation of the EMR access modules A and B 310A and 310B to the corresponding hospital/medical clinic codes of the hospital/medical clinic authentication tables 122 to register the patient numbers.

The PHR ID of the hospital/medical clinic authentication tables 122 is required for relating the patient number of the corresponding hospital/medical clinic to the PHR account of the corresponding patient. The PHR authentication unit 332 matches the PHR ID input by a patient or a doctor whose PHR ID is confirmed by the patient when access is first made to the PHR account of the corresponding patient to the corresponding patient numbers of the hospital/medical clinic authentication table 122 to register the PHR ID.

On the other hand, the doctor's office terminals 300A and 300B are connected to the EMR systems A and B 200A and 200B of the hospitals/medical clinics through their intranets, respectively and are connected to the PHR system 100 through the Internet.

Currently, a considerable number of hospitals/medical clinics connect the doctor's office terminals 300A and 300B to the Internet in order to search for information on the medicine required for treating a patient or related documents from a website outside the hospitals/medical clinics. Since a terminal, which does not have access to the Internet, does not have security problems and may be selectively allowed to access a specific site required for treatment, the doctor's office terminal may access the PHR system 100 through the Internet.

As illustrated in FIG. 4, the doctor's office terminals 300A and 300B includes PHR access modules A and B 330A and 330B for accessing the PHR system 100 in addition to the EMR access modules A and B 310A and 310B for accessing the EMR systems A and B 200A and 200B. The PHR access modules A and B 330A and 330B read the message values of events generated by the EMR access modules A and B 310A and 310B from the memories 320A and 320B of the doctor's office terminals 300A and 300B to synchronize the EMR systems A and B 200A and 200B with the PHR patient account.

That is, the EMR access modules A and B 310A and 310B read data on a patient selected by the EMR databases 220A and 220B of the EMR systems A and B 200A and 200B to display the data on screens of the doctor's office terminals 300A and 300B. Then, a doctor queries the displayed data or creates a new record. All of the events of the EMR access modules A and B 310A and 310B displaying data on the screens of the doctor's office terminals 300A and 300B store unique message values in the memories 320A and 320B of the doctor's office terminals 300A and 300B. All domestic and foreign EMR access modules 310A and 310B are basically designed to display the patient number of a patient who is being currently treated on the screens. Therefore, when an additional program installed in the same terminal reads the message value of the event of displaying the patient number of the corresponding patient from the memories 320A and 320B of the doctor's office terminals 300A and 300B, the patient number of the patient who is currently being treated may be checked without accessing the patient number databases 210A and 210B of the EMR systems A and B 200A and 200B or without synchronization with the EMR access modules A and B 310A and 310B.

When the above is described in more detail with reference to FIG. 5, the PHR access module 330 of the doctor's office terminal 300 includes the authentication unit 332 and the relay unit 331.

The authentication unit 332 reads the message value of the event generated by the EMR access module 310 from the memory 320 to check the patient number of the patient who is being currently treated and performs an authentication required for synchronizing the EMR system 200 with the PHR account with reference to the data stored in the authentication database 120 of the PHR system 100.

The relay unit 331 accesses the PHR database 110 authenticated by the authentication unit 332 to display the data on the corresponding patient on the screen of the doctor's office terminal 300 and to record the data.

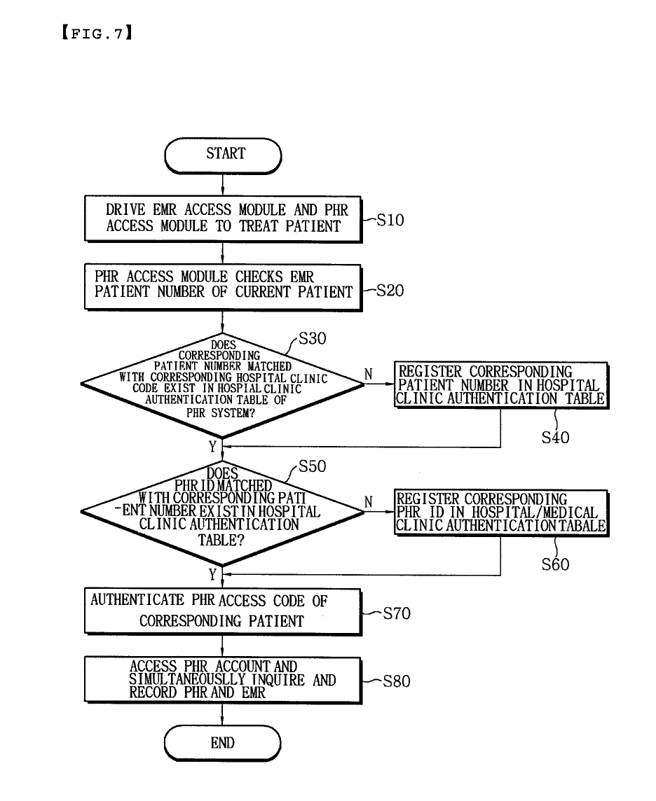

A doctor's office PC-based access method between the hospital/medical clinic EMR system according to the present invention and the Internet-based based PHR account will be described with reference to FIG. 7.

First, a doctor drives the EMR access module 310 and the PHR access module 330 from the doctor's office terminal 300 and starts to treat a patient (S10).

The doctor's office terminal 300 may be a computer used and managed by a single doctor and may be a shared computer used and managed by a plurality of doctors.

Therefore, the hospital/medical clinic code set in the PHR access module 330 of the doctor's office terminal 300 may be the identification of a hospital assigned to the corresponding hospital/medical clinic in consideration of the scale and treatment type of each hospital/medical clinic or an identification assigned to each doctor.

Moreover, a login process for checking whether a current terminal user has authority to access the PHR account of a patient through the corresponding PHR access module 330 may be further performed when the PHR access module 330 is driven.

When a patient enters a doctor's office, the doctor searches the EMR system 200 for the corresponding patient through the EMR access module 310 of the doctor's office terminal 300 to select the patient. At this time, the EMR access module 310 checks the EMR account of the corresponding patient from the patient number database 210 of the EMR system 200 and reads the data on the corresponding patient from the EMR database 220 to display the data on the screen of the doctor's office terminal 300 together with the patient number.

Therefore, the PHR access module 330 of the doctor's office terminal 300 reads the message value of the displaying event of the corresponding patient number from the memory 320 of the corresponding doctor's office terminal 300 through the authentication unit 332 to check the patient number of the patient displayed on the current EMR access module 330 (S20).

The PHR access module 330 of the doctor's office terminal 300 accesses the authentication database 120 of the PHR system 100 through the authentication unit 332 and determines whether the patient number checked in step S20 matches the hospital/medical clinic code of the corresponding doctor's office terminal 300 in the hospital/medical clinic authentication table 122 with reference to the hospital/medical clinic authentication table 122 in the corresponding authentication database 120 (S30).

When it is determined in step S30 that the corresponding patient number does not match the corresponding hospital/medical clinic code in the hospital/medical clinic authentication table 122, the authentication unit 332 of the PHR access module 330 matches the corresponding patient number with the corresponding hospital/medical clinic code to be registered in the hospital/medical clinic authentication table 122 (S40).

Then, the PHR access module 330 of the doctor's office terminal 300 checks whether the PHR ID matches the corresponding patient number with reference to the hospital/medical clinic authentication table 122 through the authentication unit 332 (S50).

When it is determined in step S50 that the PHR ID matching the corresponding patient number does not exist in the hospital/medical clinic authentication table 122, the authentication unit 332 of the PHR access module 330 displays a PHR ID input window on the screen of a terminal in which the corresponding PHR access module 330 is driven to request the input of the PHR ID. When a patient or a doctor whose PHR ID checked by the patient inputs the PHR ID of the corresponding patient, the authentication unit 332 of the PHR access module 330 matches the corresponding PHR ID with the corresponding patient number to register the corresponding PHR ID in the hospital/medical clinic authentication table 122 (S60).

Then, when the hospital/medical clinic code, the patient number, and the PHR ID are matched to the hospital/medical clinic authentication table 122 of the PHR system 100 through the above processes, the authentication unit 332 of the PHR access module 330 displays an input window on the screen of the terminal in which the PHR access module 330 is driven to request an access code to be input. When a patient inputs the access code, the patient authentication table 121 of the PHR system 100 is inquired to check whether the access code matches the access code input by the patient when the PHR account was established and to perform PHR account access authentication (S70).

When the PHR account access authentication is completed, the relay unit 331 of the PHR access module 330 accesses the PHR account of the corresponding patient stored in the PHR database 110 of the PHR system 100 to read the PHR data and to display the PHR data on the screen of the doctor's office terminal 300. The doctor performs treatment while inquiring or recording the PHR data displayed on the screen of the terminal driven by the PHR access module 330 and the EMR data displayed on the screen of the terminal driven by the EMR access module 310 (S80).

The above processes are repeated while a doctor searches for and selects a patient number of a next patient using the EMR access module 310 after the treatment of the corresponding patient is completed.

The PHR access module 330 continuously updates the data of the hospital/medical clinic authentication table 122 stored in the authentication database 120 of the PHR system 100 while repeating such processes. As a result, the PHR account of the patient matched with the patient number of the corresponding hospital/medical clinic once and the EMR screen on a patient whose treatment is currently performed are automatically synchronized with each other without additional processes of inputting the PHR ID or of authenticating the patient.

That is, the checking process may be omitted when the patient is subsequently treated. That is, the PHR access module 330 automatically extracts the patient number of the patient so that a PHR account process is performed faster through the hospital/medical clinic authentication table 122 previously matched for the corresponding patient.

The PHR account access authentication in step S70 may be allowed by the patient each time treatment is performed as described above. However, an access code field of the PHR account of the patient may be created in the hospital/medical clinic authentication table 122 of the PHR system 100 to be matched and registered so that the PHR account access authentication performed by the allowance of the patient may be omitted and may be immediately performed.

While the invention has been shown and described with respect to the exemplary embodiments, it will be understood by those skilled in the art that the system and the method are only examples of the present invention and various changes and modifications may be made without departing from the spirit and scope of the invention as defined in the following claims.

What is claimed is:

1. A PC-based access method between an electronic medical record (EMR) system and an Internet-based PHR account, comprising:
accessing the EMR system, by an EMR access module of a doctor's office terminal, connected through an intranet when treatment of a patient is begun to search for and activate EMR and patient number data of the patient;
extracting, by a personal health record (PHR) access module of the doctor's office terminal, the patient number data in the EMR of the patient currently activated from a memory of a corresponding doctor's office terminal;
accessing, by the PHR access module of the doctor's office terminal, a PHR system connected through the Internet using a set hospital/medical clinic code to check whether the extracted patient number matches the set hospital/medical clinic code in a hospital/medical clinic authentication table of the PHR system;
determining, by the PHR access module of the doctor's office terminal, whether a PHR ID matches a corresponding patient number in the hospital/medical clinic authentication table of the PHR system, upon determining that the extracted disease record number is matched with the set hospital code;
transmitting, by the PHR access module of the doctor's office terminal, a PHR account access code of the corresponding patient and comparing the PHR account access code with an access code previously registered in a patient authentication table of the PHR system to perform a PHR account access authentication, upon determining that the PHR ID matches the corresponding patient number; and
accessing, by the PHR access module of the doctor's office terminal, the PHR account of the corresponding patient stored in a PHR database of the PHR system to read PHR data and to activate the PHR data together with the EMR of the corresponding patient, when the PHR account access authentication process is completed.

2. The PC-based access method as claimed in claim 1, further comprising matching, by the PHR success module of the doctor's office terminal, the extracted patient number with the corresponding hospital/medical clinic code to register the patient number in the hospital/medical clinic authentication table of the PHR system when the extracted patient number does not match the set hospital/medical code, performed after checking whether the extracted patient number matches the set hospital/medical clinic code in a hospital/medical clinic authentication table of the PHR system.

3. The PC-based access method as claimed in claim 2, further comprising, matching, by the PHR access module of the doctor's office terminal, the PHR ID of the patient with the corresponding patient number to register the PHR ID in the hospital/medical clinic authentication table when the PHR ID matching the corresponding disease record number does not exist, after the determination as to whether PH ID matching the corresponding patient number exists in the hospital/medical clinic authentication table of the PHR system.

4. The PC-based access method as claimed in claim 1, further comprising, matching, by the PHR access module of the doctor's office terminal, the PHR ID of the patient with the corresponding patient number to register the PHR ID in the hospital/medical clinic authentication table when the PHR ID matching the corresponding disease record number does not exist, after the determination as to whether PH ID matched with the corresponding patient number exists in the hospital/medical clinic authentication table of the PHR system.

5. The PC-based access method as claimed in claim 1, further comprising performing a login for the PHR access module of the doctor's office terminal to check whether a current terminal user has authority to access the PHR account of a patient through the corresponding PHR access module before extracting the patient number data in the EMR of a patient currently activated from a memory of the corresponding doctor's office terminal.

6. The PC-based access method as claimed in 1, wherein the hospital/medical clinic code set in the PHR access module of the doctor's office terminal is an identification assigned to the corresponding hospital/medical clinic or an identification assigned to each doctor in the hospital/medical clinic.

7. The PC-based access method as claimed in claim 1, wherein, during the performance of the PHR account access authentication, an access code field for the PHR account of a patient is further created to be matched and registered in the hospital/medical clinic authentication table of the PHR system during a first authentication so as to omit the PHR account access authentication with permission of a patient.
